(19) United States
(12) Patent Application Publication
(10) Pub. No.: US 2023/0369776 A1
(43) Pub. Date: Nov. 16, 2023

(54) REFLECTOR ANTENNA ASSEMBLY

(71) Applicant: Telefonaktiebolaget LM Ericsson (publ), Stockholm (SE)

(72) Inventors: Martin JOHANSSON, Mölndal (SE); Oskar TALCOTH, Göteborg (SE); Lars MANHOLM, Göteborg (SE)

(73) Assignee: Telefonaktiebolaget LM Ericsson (publ), Stockholm (SE)

(21) Appl. No.: 18/028,162

(22) PCT Filed: Mar. 31, 2021
(86) PCT No.: PCT/EP2021/058445

§ 371 Date: Mar. 23, 2023

Related U.S. Application Data
(60) Provisional application No. 63/083,506, filed on Sep. 25, 2020.

(51) Int. Cl. H01Q 19/19; H01Q 3/20

(52) U.S. Cl. CPC H01Q 19/193; H01Q 3/20

(57) ABSTRACT

The present invention relates to a reflector antenna assembly, and a method of operating an antenna assembly wherein the reflector antenna assembly comprises a reflector having a focal region, wherein an aperture is present in a portion of the reflector; and a waveguide passing through the aperture, wherein the reflector antenna assembly is configured such that the reflector is operable to move relative to the waveguide.

### TECHNICAL FIELD

Disclosed are embodiments related to reflector antennas.

### BACKGROUND

Microwave backhaul links are increasingly used at E-band and higher frequency bands, and reflector antennas are used and envisioned as a means to provide sufficient link margin to support very high modulations. For point-to-point applications, these reflector antennas are used to provide high gain which is achieved by focusing the radiated energy in a fixed direction using, for example, pencil beams. Hence, these types of antennas are sometimes referred to as “pencil beam reflector antennas” or “beam reflector antennas,” for short. The pencil beams formed by the reflector antenna typically have small half-power beamwidths, which make the microwave link sensitive to the direction of the reflector antenna (or overall antenna system). Hence, solutions to maintain the pointing direction of such antennas are important and have garnered increasing attention from operators and reflector antenna manufacturers.

### SUMMARY

Certain challenges presently exist. For example, antennas (e.g., reflector antennas with center-fed rotationally symmetric reflectors with a localized focal region, such as a focal point for parabolic reflectors) are installed on platforms (post, tower, wall, etc.) to provide antenna gain in a specific direction, as selected during installation. For non-rigid platforms, when the installation platform moves (sways or twists) or is permanently misaligned, the beam peak will point in a direction different from the intended direction, and a conventional reflector antenna cannot compensate for the beam misalignment. Hence, if a means for sway or misalignment compensation is not provided, then there will be a deterministic drop in antenna gain dependent on the misalignment of the reflector antenna due to the platform movement or misalignment.

Accordingly, this disclosure provides embodiments to counteract the impact on antenna gain due to platform movement or misalignment. In one embodiment, a waveguide and center-fed reflector antenna is designed to allow rotation of the reflector around the feed point, i.e., the focal region in most cases, such that the reflector antenna is focused also when steered away from the nominal boresight direction. This means that the reflector antenna maintains its gain when steered, within the limits given by the illuminated reflector area and the radiation pattern of the feed. In other words, the reflector antenna offers a means for sway or misalignment compensation.

In one embodiment, the reflector is rotated by a mechanical means, for example a gimbal assembly, in either one or two dimensions, depending on the requirements and the properties (e.g. sway statistics) of the envisioned installation platform. To allow this rotation, the reflector has an aperture, through which the feed waveguide passes, with a dimension (e.g., radius for circular apertures) large enough to allow the intended angular steering interval in the one or two dimensions.

The reflector can be manufactured in various materials, including solid metal and metalized Carbon fiber reinforced polymer (CFRP), the latter potentially providing less mass to be moved by the mechanical means for rotation.

Accordingly, in one aspect, there is provided a reflector antenna assembly. The reflector antenna assembly comprises a reflector having a focal region (e.g., a focal point when the reflector is parabolic). An aperture is present in the reflector (e.g., in the center of the reflector). The reflector antenna assembly further comprises a waveguide passing through the aperture. The reflector antenna assembly is configured such that the reflector is operable to move relative to the waveguide and rotate around the feed point.

In another aspect, there is provided a method of operating an antenna assembly. The antenna assembly comprises a reflector having an aperture and a waveguide passing through the aperture. The method comprises obtaining information indicating a misalignment of the waveguide, and as a result of obtaining the information indicating the misalignment of the waveguide, triggering to move the reflector relative to the waveguide and/or rotating the reflector around the feed point.

In another aspect, there is provided a computer program comprising instructions which, when executed by processing circuitry, cause the processing circuitry to perform the method of any one of embodiments above.

The embodiments disclosed herein are advantageous in that antenna gain is maintained, or essentially maintained, over an interval of steering angles corresponding to a number of half-power beamwidths, potentially ten or more, allowing the communication system to function uninterrupted also during installation platform movement or misalignment. Moreover, in some embodiments, all electronics and feed parts are stationary, and only a passive surface, i.e., the reflector, is moveable.

### BRIEF DESCRIPTION OF THE DRAWINGS

The accompanying drawings, which are incorporated herein and form part of the specification, illustrate various embodiments.

FIG. 1 illustrates a reflector antenna assembly according to an embodiment.

FIG. 2 further illustrates a rear view of the reflector antenna assembly.

FIG. 3 further illustrates a front view of the reflector antenna assembly.

FIG. 4 shows a process according to an embodiment.

FIG. 5 shows an apparatus according to an embodiment.

### DETAILED DESCRIPTION

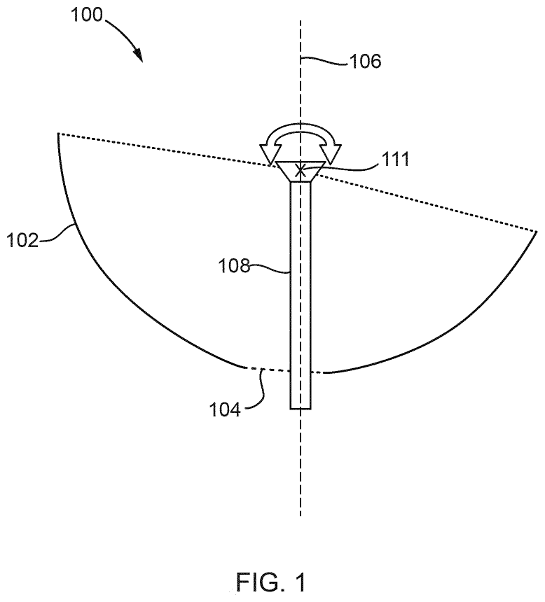

FIG. 1 illustrates a reflector antenna assembly 100 according to an embodiment. Reflector antenna assembly 100 includes a reflector 102 having an aperture (opening) 104 (in the embodiment shown aperture is located in the center of reflector 102). Reflector 102 in this embodiment is a center-fed reflector. Beam antenna assembly 100 is configured such that reflector 102 is operable to rotate relative to an axis 106 of a waveguide 108 passing through the aperture 104. The waveguide 108 has a feed point 111. That is reflector 102 is operable to rotate about feed point 111 and waveguide 108 is not physically attached to reflector 102, thereby enabling reflector 102 to rotate relative to waveguide 108 and about feed point 111. In this example, the feed point 111 is within the focal region of reflector 102. Hence, in some embodiments feed point and focal regions may be used synonymously. Advantageously, all electronics and feed parts of reflector antenna assembly stationary with respect to the moveable reflector—i.e., the reflector moves independently of the electronics and feed parts.

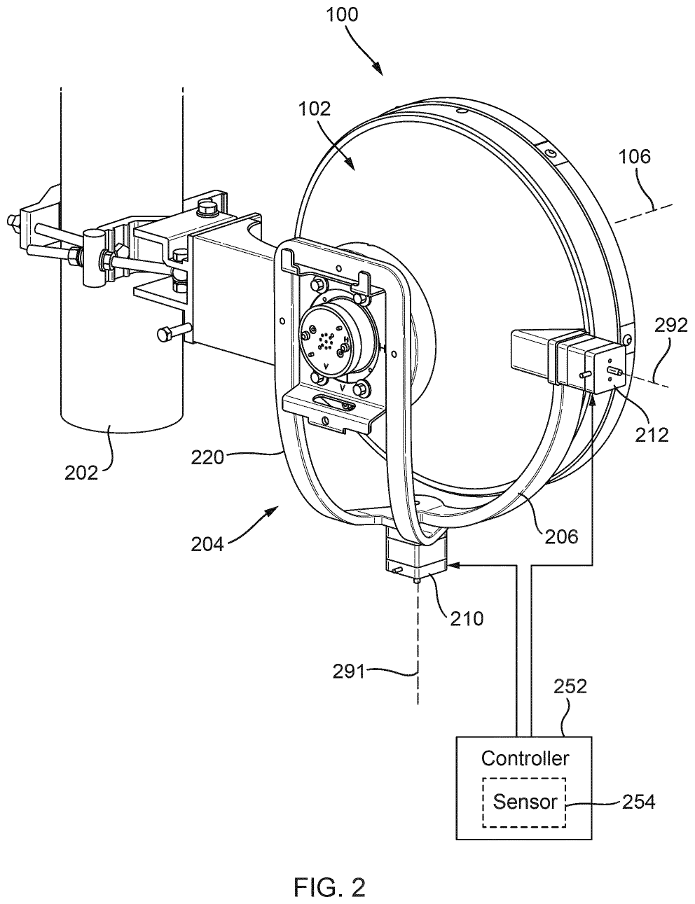

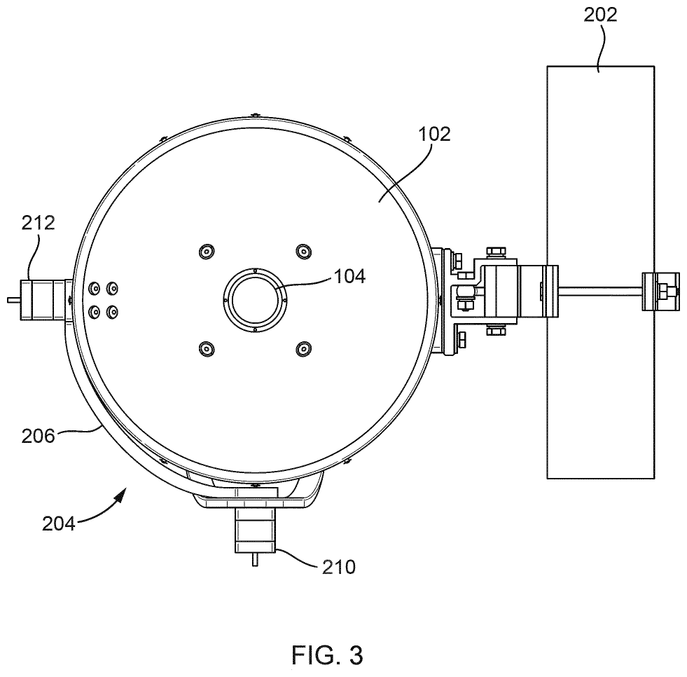

FIGS. 2 and 3 illustrate reflector antenna assembly 100 connected to a platform 202 (in this case a post). FIGS. 2 and 3 further illustrate that, in one embodiment, reflector antenna assembly 100 has a gimbal assembly 204 comprising supporting structure 220, semi-circular arm 206, and actuators 210 and 212 for enabling the rotation of reflector 102 in at least one or two dimensions relative to axis 106, depending on the requirements and the properties (e.g., sway statistics) of the envisioned installation platform.

In some embodiments, actuator 210 is coupled to the lower end of supporting structure 220 and the lower end of arm 206. Actuator 210 is configured to rotate arm 206 around axis 291. Aperture 104 allows this rotation. More specifically, the size of aperture 104 is large enough to allow intended steering of reflector 102 in one or two dimensions.

By rotating arm 206 around axis 291, the orientation of reflector 102 can be changed. For example, in FIG. 2, the orientation of reflector 102 is aligned with axis 106. By rotating arm 206 around axis 291, the orientation of reflector 102 can be changed such that it is no longer aligned with axis 106.

In some embodiments, actuator 212 is coupled to the upper end of arm 206 and a side of reflector 102. Actuator 212 is configured to rotate reflector 102 with respect to arm 206 around axis 292. By rotating reflector 102 around axis 292, the orientation of reflector 102 can be changed. For example, in FIG. 2, the orientation of reflector 102 is aligned with axis 106. By rotating reflector 102 around axis 292, the orientation of reflector 102 can be changed such that it is no longer aligned with axis 106.

Each of actuators 210 and 212 is configured to rotate reflector 102 based on command signal(s) received from a controller 252. Controller 252 may be located within reflector antenna assembly 100 or may be located outside of reflector antenna assembly 100.

In some embodiments, controller 252 may generate the command signal(s) based on sensor signal(s) received from sensor 254. Sensor 254 may comprise a single sensing unit or a plurality of sensing units, and it may be located within reflector antenna assembly 100 (or even within controller 252) or may be located outside of reflector antenna assembly 100.

Sensor 254 may be configured to detect a misalignment of waveguide 108. Thus, in some embodiments, sensor 254 may be one or more motion sensors included in reflector antenna assembly 100, which are capable of detecting movement(s) of waveguide 108. In those embodiments, after sensor 254 detects the movement(s) of waveguide 108, sensor 254 outputs sensing signal(s) to controller 252. The sensor signal(s) may indicate the movement(s) of waveguide 108.

Based on the received sensor signal(s), controller 252 may determine whether waveguide 108 is misaligned or not. For example, controller 252 may compare the value(s) of the received sensor signal(s) to threshold value(s), and as a result of determining that the value(s) of the received sensor signals are greater than the threshold value(s), controller 252 may determine that waveguide 108 is misaligned and output command signal(s) triggering actuators 210 and/or 212 to rotate reflector 102.

In other embodiments, sensor 254 is configured to detect received signal strength. For example, sensor 254 may be included in reflector antenna assembly 100 and may be configured to detect strength of a signal which is received at the reflector antenna assembly 100 from another reflector antenna assembly. In another example, sensor 254 may be included in another reflector antenna assembly and may be configured to detect strength of a signal which is received at said another reflector antenna assembly from reflector antenna assembly 100.

After detecting the received signal strength, sensor 254 may send to controller 252 sensor signal(s) indicating the received signal strength. After receiving the sensor signal(s) from sensor 254, controller 252 may compare the received signal strength to a threshold value. If the received signal strength is lower than the threshold value, it may indicate that waveguide 108 is misaligned or there is an interference in the signal path. In either case, controller 252 may generate and output command signal(s) triggering actuators 210 and/or 212 to rotate reflector 102. In some embodiments, the steps of detecting the received signal strength, comparing the received signal strength to the threshold value, and generating and outputting the command signal(s) may be repeated until the detected signal strength is greater than the threshold value.

As discussed above, in some embodiments, actuators 210 and/or 212 may be configured to rotate reflector 102 based on an occurrence of a triggering condition (i.e., receiving command signal(s) from controller 252). In other embodiments, however, actuators 210 and/or 212 may be configured to rotate reflector 102 periodically in order to find optimized alignment of waveguide 108. For example, in those embodiments where sensor 254 is configured to detect received signal strength, sensor 254 may be configured to detect received signal strength as reflector 102 rotates periodically (e.g., hours or days). In such embodiments, by periodically detecting received signal strength and rotating reflector 102, controller 252 may be configured to find an optimized alignment of waveguide 108 which results in the highest received signal strength.

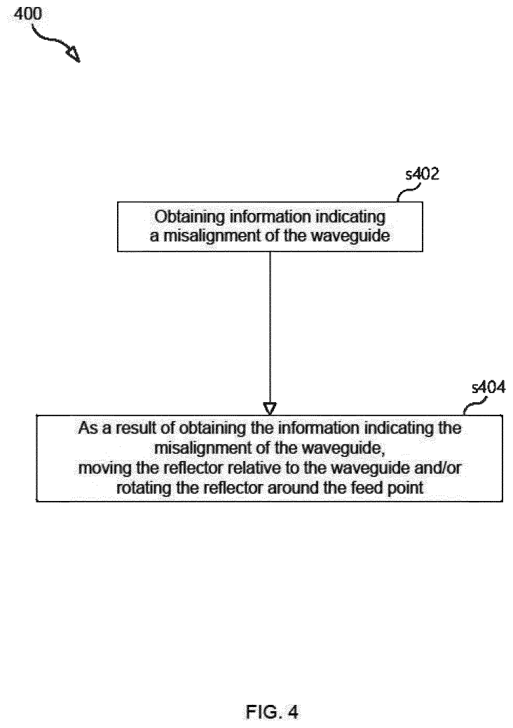

FIG. 4 is a flow chart illustrating a process 400 for operating an antenna assembly, according to one embodiment. Process 400 may begin in step s402. Step s402 comprises obtaining information indicating a misalignment of a waveguide. Step s404 comprises as a result of obtaining the information indicating the misalignment of the waveguide, moving a reflector relative to the waveguide and/or rotating the reflector around a focal region (e.g., the feed point of the waveguide).

In some embodiments, the waveguide extends along a first axis. Rotating the reflector may comprise rotating the reflector along a second axis and/or a third axis, and the first axis is different from the second axis and the third axis.

In some embodiments, the first axis is perpendicular to the second axis, the first axis is perpendicular to the third axis, and the second axis is perpendicular to the third axis.

In some embodiments, obtaining the information indicating the misalignment of the waveguide comprises detecting the misalignment of the waveguide using one or more sensors installed in the antenna assembly.

In some embodiments, detecting the misalignment of the waveguide comprises detecting a degree of a current alignment of the waveguide with respect to a reference alignment, comparing the degree of the current alignment to a threshold value, and based on the comparison, determining that the current alignment is the misalignment.

In some embodiments, obtaining the information indicating the misalignment of the waveguide comprises receiving from another antenna assembly or a control entity a signal including the information.

In some embodiments, the method further comprises receiving a signal at the antenna assembly, comparing the strength of the received signal to a threshold value, and based at least on the comparison, determining that the waveguide is misaligned.

In some embodiments, the method further comprises (i) after moving the reflector relative to the waveguide and/or rotating the reflector around the focal region, obtaining another information indicating an alignment of the waveguide, and (ii) based on the obtained said another information, determining whether the alignment of the waveguide is the misalignment. The method further comprises as a result of determining that the alignment of the waveguide is the misalignment, repeating the steps (i) and (ii).

In some embodiments, the steps (i) and (ii) are performed periodically or based on an occurrence of a triggering condition.

In some embodiments, the triggering condition is detecting a movement of the waveguide with respect to the reflector and/or detecting a drop in received signal strength.

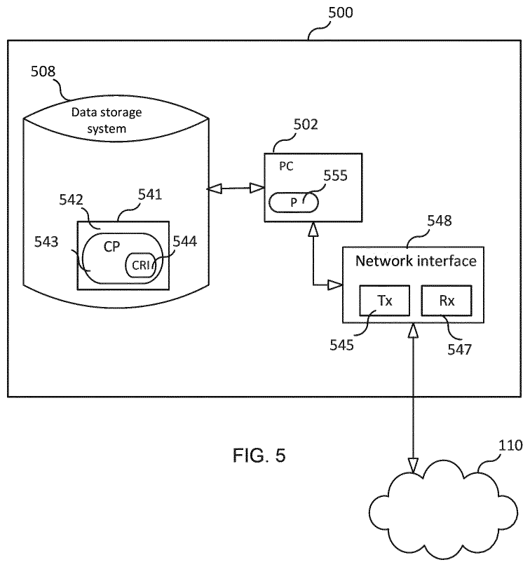

FIG. 5 is a block diagram of an apparatus 500, according to some embodiments, for implementing controller 252. As shown in FIG. 5, apparatus 500 may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 500 may be a distributed computing apparatus); a network interface 548 comprising a transmitter (Tx) 545 and a receiver (Rx) 547 for enabling apparatus 500 to transmit data to and receive data from other nodes connected to a network 110 (e.g., an Internet Protocol (IP) network) to which network interface 548 is connected (directly or indirectly) (e.g., network interface 548 may be wirelessly connected to the network 110, in which case network interface 548 is connected to an antenna arrangement); and a local storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes apparatus 500 to perform steps described herein (e.g., steps described herein with reference to the flow charts). In other embodiments, apparatus 500 may be configured to perform steps described herein without the need for code. That is, for example, PC 502 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A reflector antenna assembly, the reflector antenna assembly comprising:
a reflector having a focal region, wherein an aperture is present in a portion of the reflector; and
a waveguide passing through the aperture, wherein
the reflector antenna assembly is configured such that the reflector is operable to move relative to the waveguide.

2. The reflector antenna assembly according to claim 1,
wherein the waveguide extends along a first axis, the reflector is operable to rotate along a second axis and/or a third axis, and
the first axis is different from the second axis and the third axis.

3. The reflector antenna assembly according to claim 2,
wherein the first axis is perpendicular to the second axis,
the first axis is perpendicular to the third axis, and
the second axis is perpendicular to the third axis.

4. The reflector antenna assembly according to claim 1, the reflector antenna assembly further comprising:
an arm coupled to a side portion of the reflector, wherein the reflector is operable to rotate with respect to the arm along a first axis; and
a first actuator configured to rotate the reflector with respect to the arm along the first axis.

5. The reflector antenna assembly according to claim 4, the reflector antenna assembly further comprising:
a supporting structure; and
a signal generator disposed at a first end of the supporting structure, wherein
the signal generator is connected to the waveguide, and
the arm is disposed at and coupled to a second end of the supporting structure.

6. The reflector antenna assembly according to claim 5, the reflector antenna assembly further comprising a second actuator disposed at the second end of the supporting structure, wherein
the second actuator is configured to rotate the arm along a second axis, and
the first axis and the second axis are perpendicular to each other.

7. The reflector antenna assembly according to claim 1, the reflector antenna assembly further comprising:
a set of one or more motion detectors each of which is configured to detect a change of an alignment of the waveguide; and
a processor configured to trigger moving the reflector relative to the waveguide and/or rotating the reflector around the focal region, based on outputs from the set of one or more motion detectors.

8. The reflector antenna assembly according to claim 1, wherein the portion of the reflector is the center of the reflector.

9. A method of operating an antenna assembly, the antenna assembly comprising a reflector in a portion of the reflector and a waveguide passing through the aperture, the method comprising:
obtaining information indicating a misalignment of the waveguide, and
as a result of obtaining the information indicating the misalignment of the waveguide, triggering to move the reflector relative to the waveguide.

10. The method according to claim 9, wherein
the waveguide extends along a first axis,
rotating the reflector comprises rotating the reflector along a second axis and/or a third axis, and
the first axis is different from the second axis and the third axis.

11. The method according to claim 10, wherein the first axis is perpendicular to the second axis,
the first axis is perpendicular to the third axis, and
the second axis is perpendicular to the third axis.

12. The method according to claim 9, wherein
obtaining the information indicating the misalignment of the waveguide comprises detecting the misalignment of the waveguide using one or more sensors installed in the antenna assembly.

13. The method according to claim 12, wherein detecting the misalignment of the waveguide comprises:
detecting a degree of a current alignment of the waveguide with respect to a reference alignment;
comparing the degree of the current alignment to a threshold value; and
based on the comparison, determining that the current alignment is the misalignment.

14. The method according to claim 9, wherein
obtaining the information indicating the misalignment of the waveguide comprises receiving from another antenna assembly or a control entity a signal including the information.

15. The method according to claim 14, further comprising:
receiving a signal at the antenna assembly,
comparing the strength of the received signal to a threshold value, and
based at least on the comparison, determining that the waveguide is misaligned.

16. The method according to claim 9, further comprising:
(i) after moving the reflector relative to the waveguide and/or rotating the reflector around the focal region, obtaining another information indicating an alignment of the waveguide,
(ii) based on the obtained said another information, determining whether the alignment of the waveguide is the misalignment, and
as a result of determining that the alignment of the waveguide is the misalignment, repeating the steps (i) and (ii).

17. The method according to claim 16, wherein
the steps (i) and (ii) are performed periodically or based on an occurrence of a triggering condition.

18. The method according to claim 17, wherein the triggering condition is detecting a movement of the waveguide with respect to the reflector and/or detecting a drop in received signal strength.

19-20. (canceled)
